(19) United States
(12) Patent Application Publication
(10) Pub. No.: US 2014/0363627 A1
(43) Pub. Date: Dec. 11, 2014

(54) SURFACE HEAT SHIELD DEVICE

(71) Applicants: Anthony Potter, Richmond, VA (US); Rogier Cuylits, Summerville, SC (US)

(72) Inventors: Anthony Potter, Richmond, VA (US); Rogier Cuylits, Summerville, SC (US)

(73) Assignee: Infinite Heat Solutions, Richmond, VA (US)

(21) Appl. No.: 14/297,495

(22) Filed: Jun. 5, 2014

Related U.S. Application Data
(60) Provisional application No. 61/831,360, filed on Jun. 5, 2013.

(51) Int. Cl. F16L 59/02; B32B 15/14; B32B 3/26; B32B 5/06

(52) U.S. Cl. CPC F16L 59/029; F16L 59/028; B32B 5/06; B32B 15/14; B32B 3/266; B32B 2307/304
USPC 428/138; 442/402; 442/378

(57) ABSTRACT

A surface heat shield device may include at least one mat made from a fireproof material. The at least one mat may be hardened. The at least one mat may be placed on a rack. The rack may have a plurality of drain holes and may have a plurality of heat resistant feet attached to a bottom side of the rack. The surface heat shield device may be placed between a surface and a heat source to prevent damage to the surface from the heat source such as a fire pit.

### CROSS-REFERENCE TO RELATED APPLICATION

This application claims the benefit of U.S. provisional application No. 61/831,360, filed Jun. 5, 2013, the contents of which are herein incorporated by reference.

### BACKGROUND OF THE INVENTION

The present invention relates to outdoor heating sources and, more particularly, to a surface heat shield device.

Currently, outdoor heating sources and radiant heat can damage any surface, such as decks, patios, masonry and the like, while in use. Due to this damage, products such as, fire pits and the like, are limited in the location they can be placed. This limitation on location can negatively affect the enjoyment of the person trying to use the outdoor heating source.

As can be seen, there is a need for a surface heat shield device that protects surfaces from radiant heat from any heat source.

### SUMMARY OF THE INVENTION

In one aspect of the present invention, a surface heat shield device comprises: at least one mat made from a fireproof material, wherein the at least one mat is hardened.

In another aspect of the present invention, a method for protecting a surface from radiant heat comprises: creating fibers from a fireproof material; opening the fibers; needle punching the fibers to form a pad of fibers; cutting the pad and placing the pad of fibers within a mold; heating the fibers with a high temperature resin, wherein the high temperature resin allows the fibers to bond together into a hardened mat, wherein the mat is a surface heat shield device; and placing the assembled surface heat shield device in between a surface and a heat source.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention shown in use;

FIG. 2 is a perspective view of an exemplary embodiment of the present invention;

FIG. 3 is a bottom perspective view of an exemplary embodiment of the present invention;

FIG. 4 is a detail section view of an exemplary embodiment of the present invention along line 4-4 in FIG. 3; and

FIG. 5 is an exploded view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a surface heat shield device that may include at least one mat made from a fireproof material. The at least one mat may be hardened. The at least one mat may be placed on a rack. The rack may have a plurality of drain holes and may have a plurality of heat resistant feet attached to a bottom side of the rack. The surface heat shield device may be placed between a surface and a heat source to prevent damage to the surface from the heat source such as a fire pit.

The present invention may be used to stop radiant heat from damaging surfaces. At least one mat made from a fireproof material such as volcanic rock fibers may be placed in a rack that may be rust proof. The rack may be used to keep surfaces free of moisture to avoid watermarks and allow water to work through the at least one mat so that the material may stay dry.

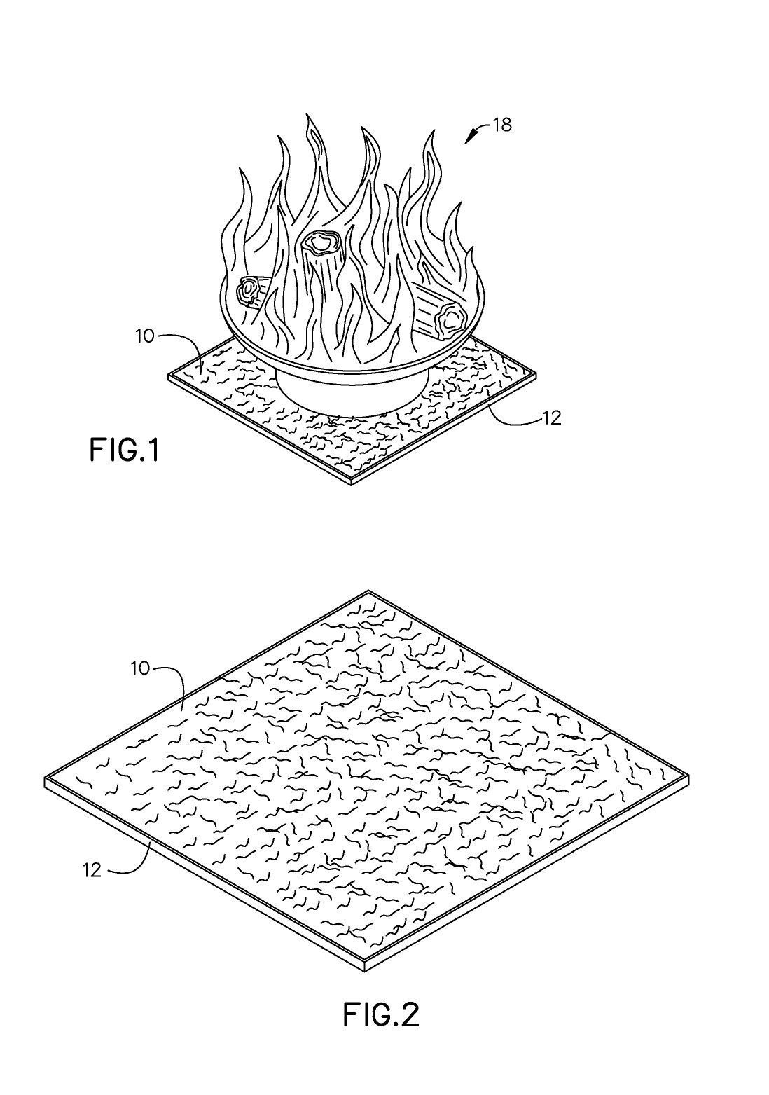

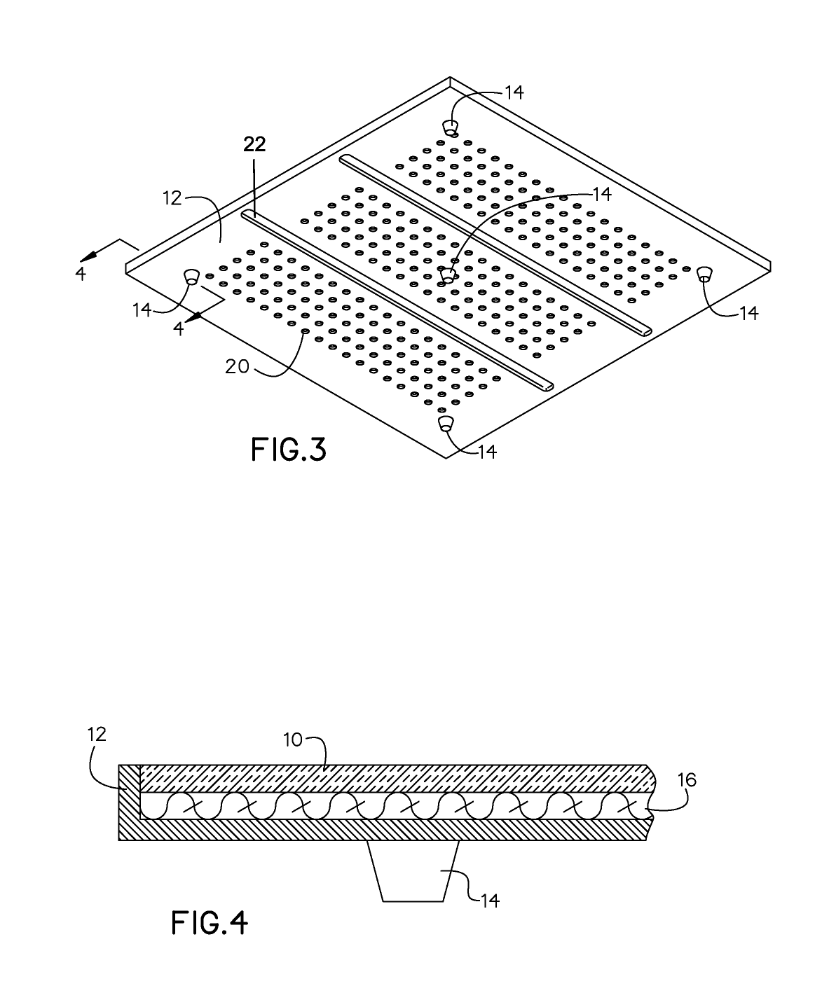

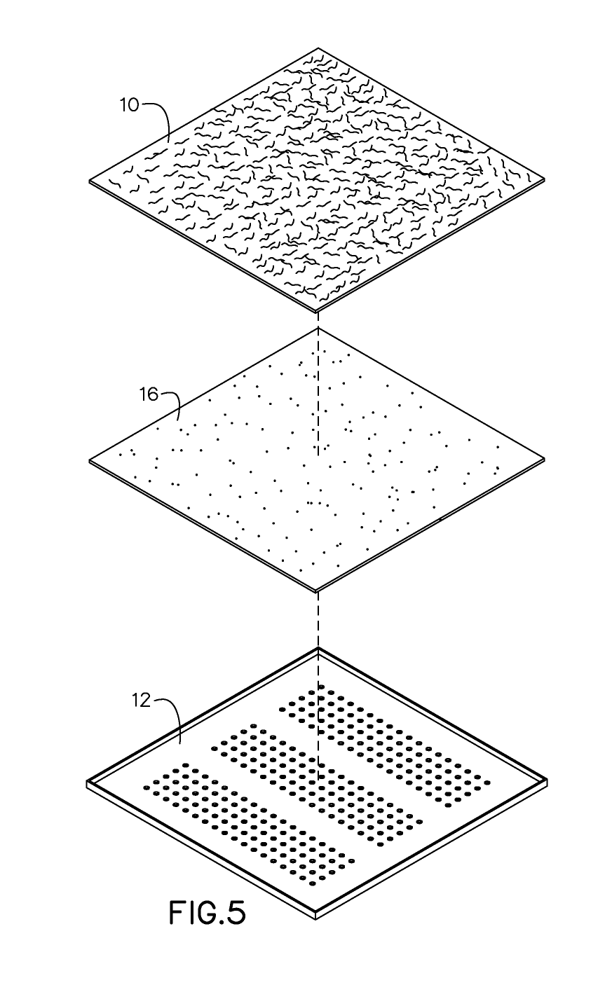

As is illustrated in FIGS. 1 through 5, a surface heat shield device may include a rack 12. In certain embodiments, the rack 12 may be made from a material that may withstand high temperatures like aluminum, high temperature plastic, or the like. The rack 12 may have a bottom side and a top side. In certain embodiments, a plurality of feet 14 may be attached to the bottom side of the rack 12. The plurality of feet 14 may be made from heat resistant rubber, metal or the like. The rack 12 may also have a plurality of drain holes 20. In certain embodiments, the rack 12 may include a plurality of channels 22 set in the bottom side of the rack 12. The plurality of channels 22 may help the load capacity of the rack 12. In certain embodiments, the rack 12 may have walls to keep other components positioned within the rack 12 structure. In certain embodiments, the rack 12 may be a flat pan that other components may be placed upon. The plurality of feet 14 may provide an additional level of insulation from the radiant heat of a heat source 18 to the surface that is being protected.

A fireproof material such as volcanic rock fibers, ceramics, basalt, silica, or the like, may be configured into at least one mat 10. In certain embodiments, a second fireproof material 16 may be placed below the at least one mat 10.

A method of making the surface heat shield device may include the following. Fireproof material such as volcanic rock, glass, silica, ceramics, or the like, may be chopped into fibers. The fibers may be opened, and then needle punched into an approximate felt pad. The pad may be cut to a particular size and placed within a mold. The content within the mold may then be formed while applying a high temperature resin that may bond the fibers together. The resin may penetrate and then bond the fibers together. The type of resin may depend on the specific fireproof material used. In certain embodiments, the resin may be phenolic based. The product may then be cured environmentally, or with additional heat. The product may be placed into a kiln and heated for a specific amount of time. In certain embodiments, the product may be placed in the kiln to decrease drying time. Once fully dried, the product becomes a rigid, yet flexible mat 10. The mat 10 may harden and stay hardened. In certain embodiments, the mat 10 may be cut into a desired size and placed directly on a surface to protect the surface. In certain embodiments, the mat 10 may then be cut into a desired size and placed into the rack 12.

A method of using the surface heat shield device may include the following. A user may place the surface heat shield device on a particular surface, such as a deck floor, or the like. A heat source 18 may then be placed above the surface heat shield device. The heat source 18 may be placed directly upon the surface heat shield device. The heat source 18, having legs or the like, may also be placed above the surface heat shield device. The approximate center of the heat source 18 may be placed directly above the approximate center of the device. Heat sources 18, such as a fire pit, generally burn to only 900-1100 degrees Fahrenheit, which may be within the fireproof range of the device. In certain embodiments, the device may be fireproof up to 3000 degrees Fahrenheit.

It should be understood, of course, that the foregoing relates to exemplary embodiments of the invention and that modifications may be made without departing from the spirit and scope of the invention as set forth in the following claims.

What is claimed is:

1. A surface heat shield device comprising:
at least one mat made from a fireproof material, wherein the at least one mat is hardened.

2. The surface heat shield device of claim 1, further comprising a rack having a bottom side and a top side, wherein the mat is positioned above the top side of the rack.

3. The surface heat shield device of claim 2, wherein the rack further comprises a plurality of drain holes.

4. The surface heat shield device of claim 2, further comprising heat resistant feet attached to the bottom side of the rack.

5. The surface heat shield device of claim 2, wherein the rack is made from aluminum.

6. A method for protecting a surface from radiant heat comprising:
creating fibers from a fireproof material;
opening the fibers;
needle punching the fibers to form a pad of fibers;
cutting the pad and placing the pad of fibers within a mold;
heating the fibers with a high temperature resin, wherein the high temperature resin allows the fibers to bond together into a hardened mat, wherein the mat is a surface heat shield device; and
placing the assembled surface heat shield device in between a surface and a heat source.

7. The method of claim 6, wherein the surface heat shield device further comprises a rack having a bottom side and a top side, wherein the mat is positioned on top of the top side of the rack.

8. The method of claim 7, wherein the rack further comprises a plurality of drain holes.

9. The method of claim 7, wherein the rack further comprises heat resistant feet attached to the bottom side of the rack.

10. The method of claim 7, further comprising the step of placing a second fireproof material in between the mat and the rack.
